(19) United States
(12) Patent Application Publication
(10) Pub. No.: US 2015/0020500 A1
(43) Pub. Date: Jan. 22, 2015

(54) MICRO GAS TURBINE SYSTEM HAVNIG AN ANNULAR RECUPERATOR

(71) Applicant: Babcock Bosig Steinmuller GmbH, Oberhausen (DE)

(72) Inventors: Lina Kling, Berlin (DE); Frieder Neumann, Berlin (DE); Mathias Born, Berlin (DE); Karl-Friedrich Schroder, Grunstadt (DE); Thomas Dziekan, Berlin (DE); Holger Alder, Berlin (DE); Ornella Mattner, Konigs Wusterhausen (DE)

(73) Assignee: BABCOCK BORSIG STEINMULLER GMBH, Oberhausen (DE)

(21) Appl. No.: 14/380,159

(22) PCT Filed: Feb. 19, 2013
(86) PCT No.: PCT/EP2013/000482

§ 371 Date: Aug. 21, 2014

(30) Foreign Application Priority Data
Feb. 21, 2012 (DE) 102012003347.8
Feb. 21, 2012 (DE) 102012003348.6

(51) Int. Cl. F02C 7/10

(52) U.S. Cl. CPC F02C 7/10
USPC 60/39.511

(57) ABSTRACT

A micro gas turbine system (16) having an annular recuperator (24). The recuperator (24) serves to transfer heat from an exhaust stream (27) of the turbine (17) to an air stream (23) compressed by a compressor (19). Passages (1) for the exhaust stream (27) and passages (2) for the air stream (23) are arranged in alternation to each other in the recuperator (24). Adjacent passages (1, 2) are separated from each other by at least one wall (15). A filler (5) is arranged in the passages (1, 2) of at least one fluid stream.

### BACKGROUND

The invention relates to a micro-gas turbine plant with a turbine, a compressor and an annular recuperator for heat transfer from an exhaust gas flow to an airflow, wherein passages for the exhaust gas flow and passages for the airflow are arranged in an alternating manner to each other in the recuperator and adjacent passages are separated from each other by means of at least one wall.

Recuperators are heat exchangers, in which heat is transferred from a hotter fluid flow to a colder fluid flow which is spatially separated therefrom, wherein the two fluids are not intermixed with each other.

The invention relates to a micro-gas turbine plant with an annular recuperator. This has a hollow cylindrical cross section. The hot exhaust gas flow of the turbine flows through the annular recuperator and transfers heat to the airflow. Downstream of the annular recuperator, the heated airflow is converted with a fuel gas in a combustion chamber.

In WO 2005/045345 A2, an annular recuperator for a micro-gas turbine plant is described. The hot exhaust gas flow and the airflow are separated from each other by means of metal sheets which are provided with corrugations. As a result of such metal sheets, optimum heat transfer is not ensured since the intermixing within the fluid flows being transferred is simply inadequate and therefore high temperature gradients occur within the fluid flows.

WO 02/39045 A2 shows an annular recuperator with a multiplicity of hot and cold cells. Projections are attached on the surfaces which separate the hot cells from the cold cells. The production of such surfaces is costly and also ensures only an inadequate heat transfer.

### SUMMARY

It is the object of the invention to provide a micro-gas turbine plant with an annular recuperator, with passages for a hotter fluid flow and passages for a colder fluid flow, in which heat transfer from the hotter fluid flow to the colder fluid flow is improved. The micro-gas turbine plant is to have an efficiency which is as high as possible. The micro-gas turbine plant is to be distinguished by a simple and inexpensive production method. Moreover, the micro-gas turbine plant is to fulfill high safety standards and to be easy to maintain. In particular, loss of sealing, during which fuel gas, exhaust gas or compressed air can escape, is to be avoided.

This object is achieved according to the invention by a filler being arranged in the passages of at least one fluid flow.

This filler ensures an intermixing within the fluid flow when flow passes through the passages and therefore ensures better heat transfer. In contrast to conventional recuperators, in which only profiled metal sheets are used, the filler in the passages effects better intermixing so that temperature gradients within the fluid flow are reduced.

The filler forms a frame which supports the walls. Therefore, the walls can be of a very thin construction, which contributes to further improvement of the heat transfer. The filler is preferably not connected to the walls in a flat manner.

In a particularly favorable embodiment of the invention, the filler is formed of a wire arrangement. In principle, the wires can extend in any directions within this arrangement in this case and form a type of “wire bundle”. It proves to be particularly favorable, however, if the wire arrangement is constructed as a wire mesh. The wire mesh preferably is formed of wires which extend in the axial and in the radial direction. As a result of this orientation of the wires, the flow resistance is reduced and therefore the pressure loss when flow passes through the recuperator is reduced.

The wires preferably consist of metal and have a circular cross section. In this case, stainless steel is suitable for their production. In a particularly favorable embodiment of the invention, the wires which extend in the axial direction have a larger diameter than the wires which extend in the radial direction. The diameter of the axial wires is preferably larger than 1.6 mm, especially larger than 1.8 mm and/or smaller than 2.4 mm, especially smaller than 2.2 mm. The diameter of the radial wires is preferably larger than 1.0 mm, especially larger than 1.2 mm and/or smaller than 1.8 mm, especially smaller than 1.6 mm.

In a particularly advantageous variant of the invention, the walls are formed of a metal foil. The foil is supported by the filler. As a result, the foil can also withstand higher pressure differences between both fluid flows. The metal foil preferably has a thickness of less than 0.2 mm, especially less than 0.15 mm and/or more than 0.08 mm, especially more than 0.1 mm. Steel is suitable as material for the foil, wherein stainless steel, preferably a high-alloy steel, for example X6CrNiTi 18-10, is particularly favorable.

The walls preferably have a curved shape. They form evolvents which extend from an inside diameter to an outside diameter. In an advantageous embodiment of the invention, the recuperator has an inner and/or outer, especially metallic, casing surface. The walls preferably extend between the inner and the outer casing surface. The walls are preferably arranged parallel to each other.

In a variant of the invention, the casing surfaces are formed from an inner and an outer tube.

In a particularly favorable variant of the invention, the inner and/or outer casing surface are, or is, formed from a bent sheet metal strip. This sheet metal strip is formed to form the respective cylindrical casing surface. Inlet openings and/or outlet openings can be introduced into the sheet metal strip for the exhaust gas flow of the turbine. The openings are preferably punched in. The production of such an inner and outer casing surfaces is particularly inexpensive. Such casing surfaces, which are formed from sheet metal strips, are distinguished by a low weight.

If the outer casing surface is formed from a slightly thicker-walled tube compared with the sheet metal strip, then it proves to be favorable if the outer tube on its inner side and/or the inner tube on its outer side have, or has, axial grooves. These elongated recesses can be cut in in the axial direction on the outer side of the inner tube or on the inner side of the outer tube.

The grooves enable a structured arrangement of the fillers and walls inside the recuperator. To this end, prefabricated elements can be produced for the passages of a fluid flow. Each element is formed of a filler which is laterally closed off by a wall.

At the top and bottom, i.e. towards the inner and the outer tubes, the elements are provided with a strip in each case. The strips are welded to the walls.

For constructing the recuperator, first of all individual shingles are preferably produced from at least two walls with corresponding strips and covers. A plurality of shingles can then form a cassette. A cassette is a module of the recuperator. These cassettes are compact sub-assemblies from which the recuperator is assembled in a preferably modular type of construction.

The elements are positioned in the space between the inner and outer casing surfaces. In a variant, an inner and an outer groove serve as a guide for the inner and outer strips of each element. At the front and rear front sides, these elements are open so that a fluid flow can flow into and out of the elements in the axial direction.

The recuperator is constructed in steps. After the positioning of an element, a filler is positioned next to the element. The filler is supported on the inner and outer tubes in each case by projections which are produced as a result of the cutting in of the grooves in the axial direction.

At the front and rear end sides, this filler is closed off by a cover in each case. Metal sheets, which also preferably have a curved shape, can be used as covers. The metal sheets extend from the inner tube to the outer tube. They are welded to the walls of the elements.

Alternatively, strips can also be used as covers, wherein these preferably have a rectangular or square profile so that the covers are formed as elongated cuboid metal bodies which are preferably positioned on a wall on a long side and are welded to this.

For producing the recuperator, it proves to be favorable in this case if covers are first of all welded onto two walls. The two walls with their covers are then aligned with each other. At the place where adjacent covers meet each other, these are welded to each other. The two covers which are welded to each other preferably close off the passages for the exhaust gas flow of the turbine at the end sides of the annular recuperator. At the end sides of the recuperator, the passages for the compressed airflow are open.

In an alternative embodiment of the inventions, walls are flanged onto covers. The walls in this case are preferably formed as metal foils. A cover is welded to a foil and the foil of the adjacent shingle is flanged onto this cover. As a result, inaccuracies during manufacture can be compensated, especially if the walls are excessively long. The projecting part of the foil is flanged over.

The annular recuperator at least partially encloses a combustion chamber of the micro-gas turbine plant. In a particularly advantageous variant of the invention, the micro-gas turbine plant comprises a recuperator which completely encloses the combustion chamber.

### BRIEF DESCRIPTION OF THE DRAWINGS

Further features and advantages of the invention come from the description of exemplary embodiments with reference to drawings and from the drawings themselves.

In the drawing:

FIG. 1 shows an enlarged view of exhaust-gas passages and air passages, arranged in an alternating manner to each other, of an annular recuperator,

FIG. 2 shows an exploded drawing of components for designing the passages,

FIG. 3 shows the front side of the outer tube,

FIG. 4 shows the rear side of the inner tube,

FIG. 5 shows an axial section through a micro-gas turbine plant,

FIG. 6 shows a shingle with an alternative variant of closing off the passages,
a as an axial front view,
b as a perspective view,

FIG. 7 shows a cassette with a plurality of shingles,
a as an axial front view,
b as a perspective view,

FIG. 8 shows a cassette with clamping plates,
a as an axial front view,
b as a view enlargement of the region A,
c as a perspective view,

FIG. 9 shows a cassette without clamping plates,
a as an axial front view,
b as a view enlargement of the region B,
c as a perspective view.

### DETAILED DESCRIPTION OF THE PREFERRED EMBODIMENTS

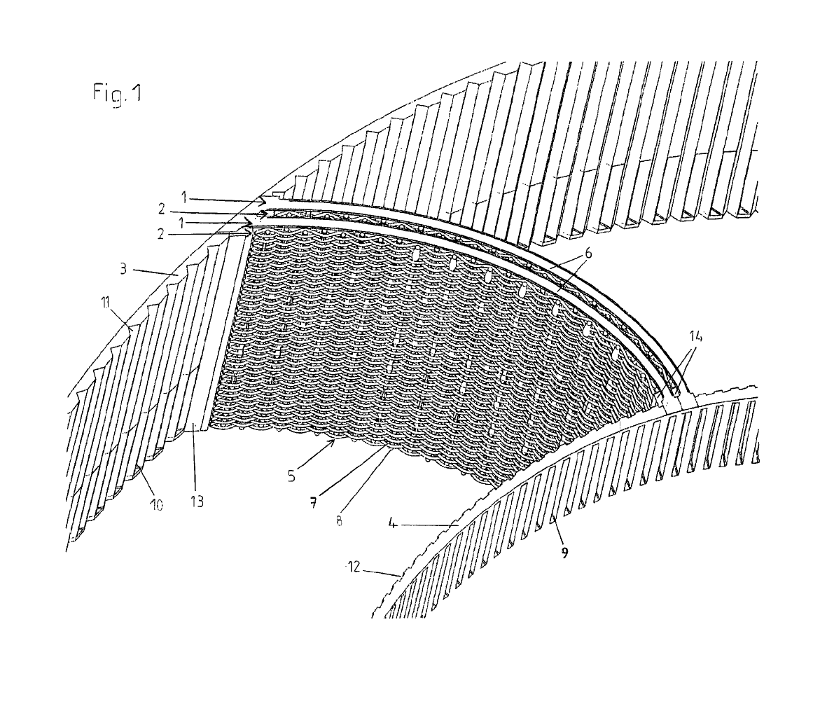

FIG. 1 shows a detail of an annular recuperator 24. The recuperator 24 comprises passages 1 for a hotter fluid flow and passages 2 for a colder fluid flow. In FIG. 1, for reasons of clarity, only four passages 1, 2 are shown by way of example. The passages 1, 2 are arranged in an alternating manner to each other. They fill out the entire space of the recuperator 24 between an outer tube 3 and an inner tube 4.

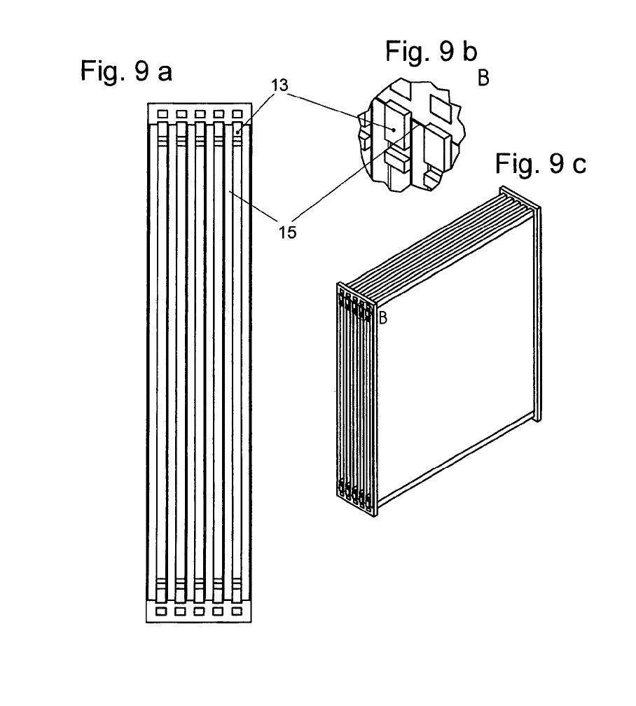

The recuperator 24 is part of micro-gas turbine plant 16 which is shown in FIG. 5. The colder fluid flow 23 is an intake airflow which is preheated in the annular recuperator before it is fed to a combustion chamber 25. The hotter fluid flow 27 is the hot exhaust gas flow of the micro-gas turbine plant 16, which transfers heat to the airflow when flowing through the recuperator 24.

The annular recuperator, in the variant shown in FIG. 1, has an inner tube 4 and an outer tube 3. Arranged between the two tubes 3, 4 are the passages 1, 2 for the two fluid flows. In the exemplary embodiment, a filler 5 is arranged in each passage 1 for the hot exhaust gas flow 27 and in each passage 2 for the cold airflow 23 respectively. The fillers 5 in the passages 1 for the hot exhaust gas flow 27 are concealed by covers 6 and are therefore not visible in the view according to FIG. 1.

The fillers 5 are formed of a wire arrangement. This wire arrangement is constructed as a wire mesh in which wires 7 which extend in the radial direction are guided in an alternating manner over and under wires 8 which extend in the axial direction. The wires 7 which extend in the radial direction have a diameter of 1.4 mm. The wires 8 which extend in the axial direction have a diameter of 2 mm.

The inner tube 4, in this variant, has openings at one end. The openings are formed as longitudinal slots which extend in the axial direction. The openings form radial inner inlets 9 for the exhaust gas flow 27.

The outer tube 3, in this variant, also has openings which are formed as longitudinal slots which extend in the axial direction. The openings form radial outer outlets 10 for the exhaust gas flow 27.

The outer tube 3, in this variant, has grooves 11 which on its inner side extend in the axial direction. The inner tube 4 has grooves 12 which on its outer side extend in the axial direction.

In the passages 2 for the airflow, strips 13 are arranged between the grooves 11 of the outer tube 3 and the filler 5. The strips 13 partially engage in the grooves 11 and support the filler 5. Furthermore, in the passages 2 for the airflow, strips 14 are arranged between the grooves 12 of the inner tube 3 and the filler 5. These strips 14 partially engage in the grooves 12 and support the filler 5. The strips 13, 14 are welded to the corresponding walls 15.

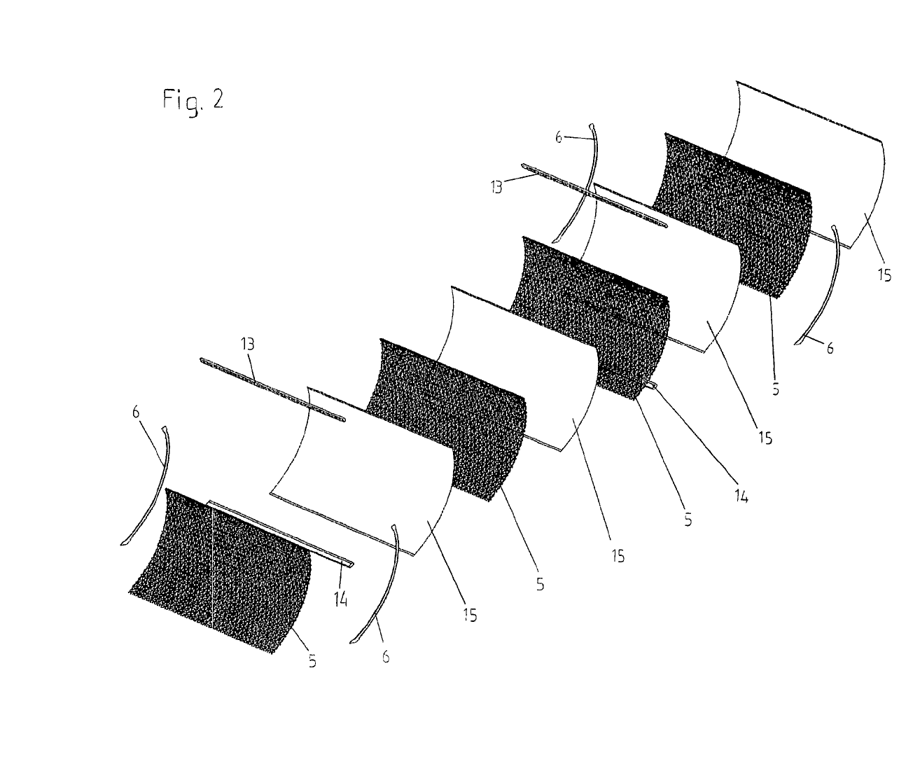

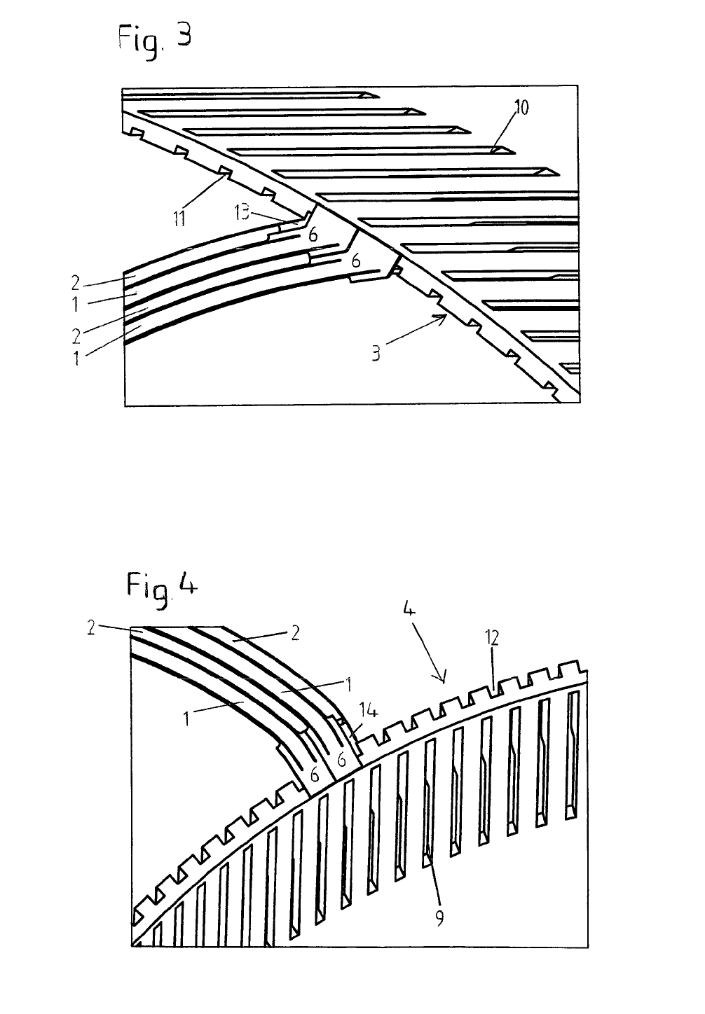

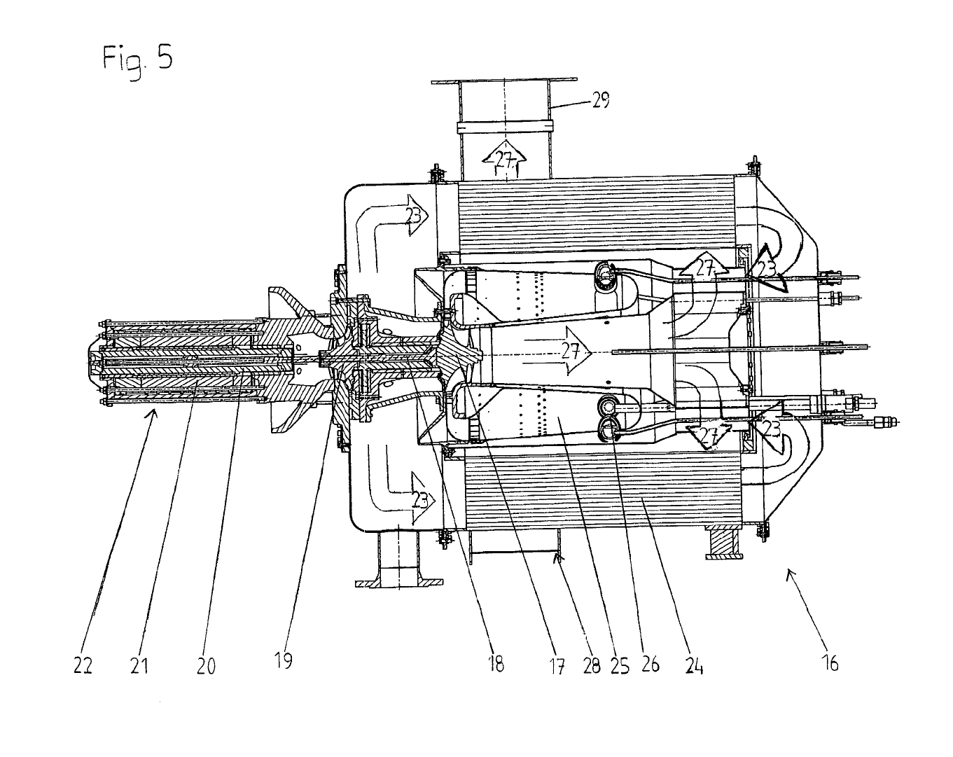

Shown in FIG. 2 is an exploded drawing of components for designing the passages 1, 2. Shown on the far left is the filler 5 of a passage 1 for the hot exhaust gas flows. All the fillers 5 are formed of a wire mesh. Covers 6 are attached at the front and rear end sides of the passages for the hot fluid flow. The covers 6 are welded to the walls 15. All the walls 15 are foils with a thickness of 0.125 mm, which consist of steel 1.4541, X6CrNiTi 18-10.

The walls 15 separate the passages 1 for the hot exhaust gas flow from passages 2 for the cold airflow.

A filler 5, which is formed of a metallic wire mesh, is also arranged in the passage 2. A strip 13 is arranged between the filler 5 and the outer tube 3. A strip 14 is arranged between the filler 5 and the inner tube 4.

The construction proceeds in this sequence until the entire space of the annular recuperator between the outer tube 3 and the inner tube 4 is filled out. In this case, both the walls 15 and the fillers 5 have a curved shape and form evolvents which extend between the two tubes 3, 4.

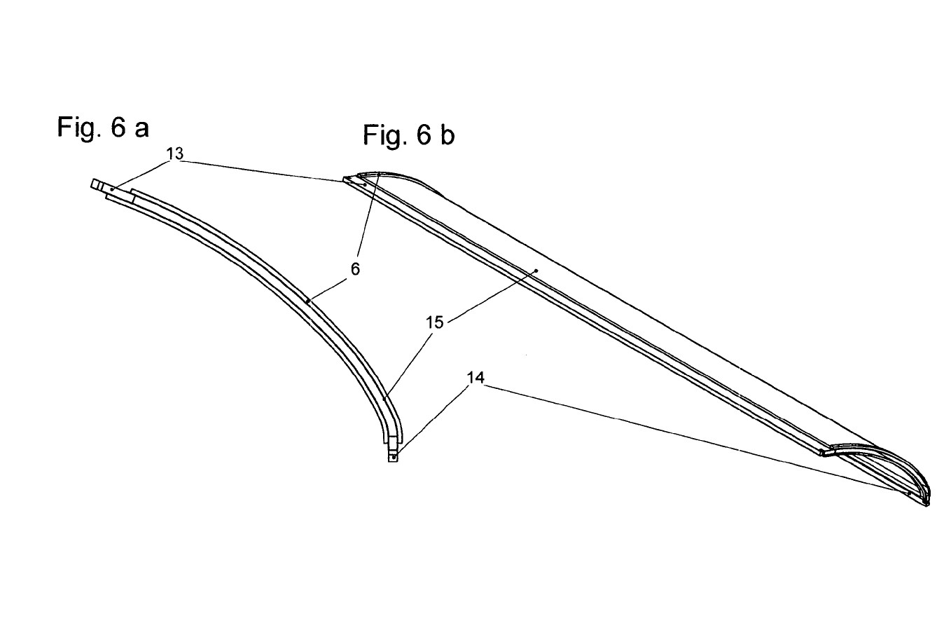

FIG. 3 shows a detail of the outer tube 3 viewed from the air inlet side. The air enters the passages 2, flows through the recuperator in the axial direction and discharges again in the axial direction on the opposite side. The hot exhaust gas flows through the passages 1. The end sides are closed off by covers 6. The hot exhaust gas exits the recuperator through radial outer outlets 10. The outer tube 3 has grooves 11 which extend in the axial direction on the inner side of the outer tube 3. The grooves 11 serve for partially accommodating the strips 13 which are arranged between the outer tube 3 and the filler 5 of the passages 2 for the airflow.

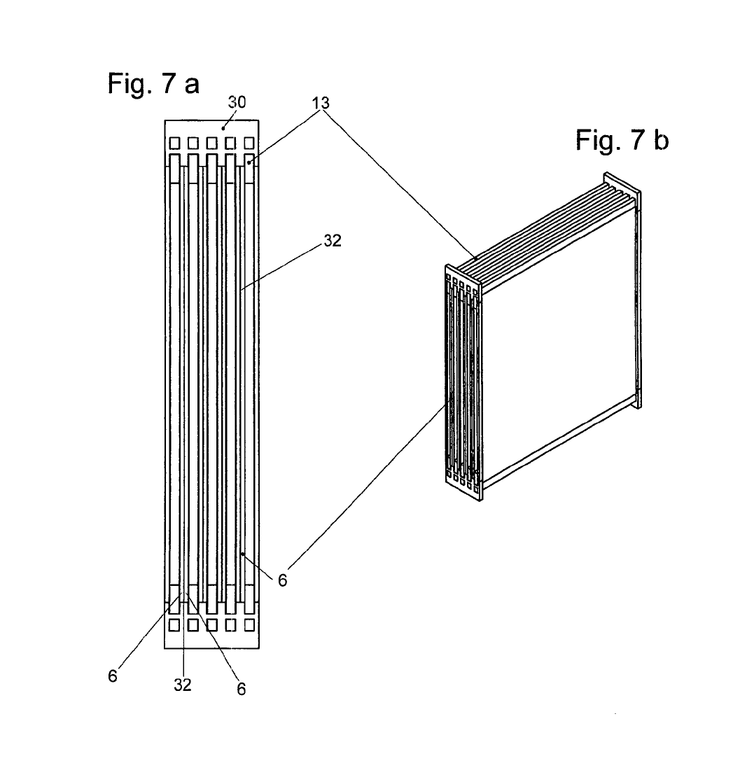

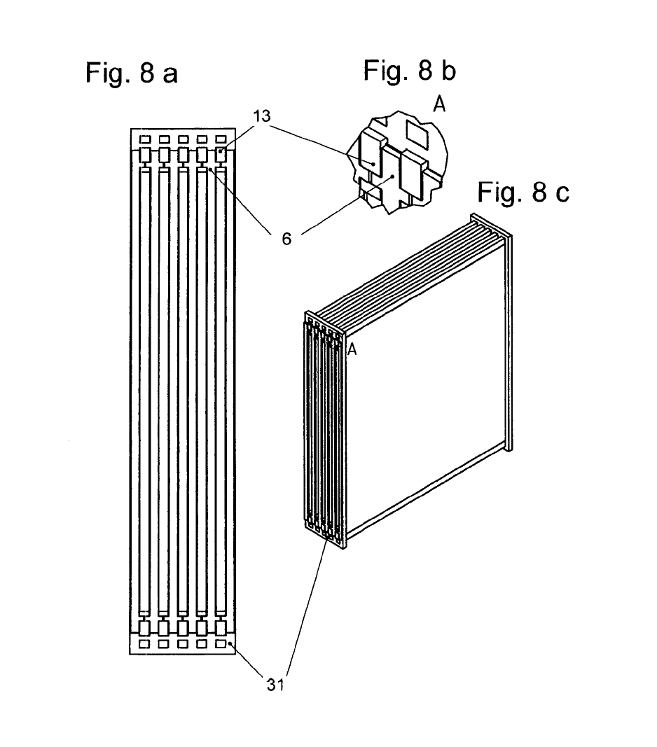

FIG. 4 shows a detail of the inner tube 4 viewed from the air outlet side. The air exits the passages 2 in the axial direction. The hot exhaust gas flow enters the recuperator through the inner radial inlets 9, flows through the passages 1 in the axial direction and exits the recuperator through the outer radial outlets 10. The end sides of the passages 1 are closed off by covers 6. The inner tube 4, on its outer side, is provided with grooves 12 which extend in the axial direction. The grooves 12 serve for partially accommodating the strips 14 which are arranged between the inner tube 4 and the filler 5 of the passages 2 for the airflow.

FIG. 5 shows a micro-gas turbine plant 16 with a turbine 17 which drives a shaft 18. A compressor 19 and a rotor 20 are arranged on the shaft 18. The compressor 19 is a single-stage radial compressor. A single-stage radial turbine is used as the turbine 17. The rotor 20 is enclosed by a stator 21. The rotor 20 and the stator 21 are component parts of a generator 22 which serves for power generation.

Air is inducted and compressed by the compressor 19. The airflow 23 flows axially into the annular recuperator 24 and flows out axially on the opposite side. In the recuperator 24, the airflow 23 is heated and flows to a combustion chamber 25. The combustion chamber 25 comprises burners 26 in which a fuel gas is combusted with the preheated air to form exhaust gas. The fuel gas is directed to the burners 26 via feed lines.

The exhaust gas flows through the turbine 17 and drives this. The expanded exhaust gas flow 27 flows radially into the recuperator 24, flows through the recuperator 24 in the axial direction and flows radially out of the recuperator 24. The cooled exhaust gas flow 27 flows into an annular exhaust-gas collector 28 and exits the micro-gas turbine plant 16 through an exhaust-gas stack 29.

The annular recuperator 24 has a hollow cylindrical geometry. It extends in the axial direction and encloses the combustion chamber 25 in the exemplary embodiment.

FIGS. 6 a and 6 b show a shingle of the recuperator 24. A shingle is a sub-assembly of the recuperator 24. The recuperator 24 is preferably constructed from a multiplicity of shingles, preferably from more than one hundred and twenty, especially from more than one hundred and fifty shingles. In the exemplary embodiment, the recuperator 24 is constructed from one hundred and eighty five shingles.

FIGS. 6 a and 6b show an alternative construction of such a shingle. Covers 6 are welded to the walls 15 which are constructed as metal foils. In the production of the individual shingles, covers 6 are first of all welded onto the exhaust-gas side of walls 15 axially at the front and axially at the rear. For forming a shingle, a strip 13 is inserted radially on the outside and a strip 14 is inserted radially on the inside between two walls 15 in each case.

FIGS. 7a and 7 b show a cassette. In the view, only an exemplary number of shingles is shown. For reasons of clarity, the figures show shingles without a curved shape. A cassette is a module of the recuperator 24. These cassettes are compact sub-assemblies from which the recuperator 24 can be assembled. The recuperator 24 preferably is formed of more than five such modules and less than ten such modules. Each module preferably comprises more than ten and less than forty such shingles, especially more than fifteen and less than thirty five shingles. A comb 30 serves for the fixing and/or connecting of the individual elements. The metal comb 30 is preferably welded to adjoining elements.

For closing off a passage 1 of the exhaust gas flow 27 at the end sides of the recuperator 24, a plurality of covers 6, which are interconnected, can also be used. Adjoining covers are preferably welded to each other.

For producing the recuperator 24, it proves to be favorable in this case if covers 6 are first of all welded onto two walls 15. The two walls 15 with their covers 6 are then aligned with each other. At the place where adjacent covers 6 meet each other, these are welded to each other. In this case, a welded seam 32, which extends between the two covers 6, is formed. The welded seam 32 extends between the adjacent covers 6 in the radial direction on the end sides of the recuperator 24. In this case, two covers 6 which are welded to each other always close off a passage 1 of the exhaust gas flow 27. The passages 2 for the compressed airflow 23 are open at the end sides of the recuperator 24.

FIGS. 8 a, 8 b and 8 c show a variant with clamping plates as covers 6. For reasons of clarity, the figures show shingles without a curved shape. A reflective plate 31 serves for the fixing and/or connecting of the individual elements. The metal reflective plate 31 is preferably welded to the adjacent elements.

FIGS. 9 a, 9 b and 9 c show a variant without clamping plates, wherein the walls 15, formed as metal foils, are flanged. For reasons of clarity, the figures show shingles without a curved shape. A cover 6 is first of all welded to a wall 15. A wall 15 of the adjacent shingle is flanged onto the cover 6.

Laser welding is especially suitable as the welding method.

1. A micro-gas turbine plant (16) comprising a turbine (17), a compressor (19), and an annular recuperator (24) for heat transfer from an exhaust gas flow (27) to an airflow (23), the recuperator including passages (1) for the exhaust gas flow (27) and passages (2) for the airflow (23) that are arranged in an alternating manner to each other and adjacent ones of the passages (1, 2) are separated from each other by at least one wall (15), and a filler (5) is arranged in the passages (1, 2) of at least one fluid flow.

2. The micro-gas turbine plant as claimed in claim 1, wherein the filler (5) comprises a wire arrangement.

3. The micro-gas turbine plant as claimed in claim 2, wherein the filler (5) comprises a wire mesh.

4. The micro-gas turbine plant as claimed in claim 3, wherein the wire mesh is formed of wires (7) which extend in an axial direction and wires (8) which extend in a radial direction.

5. The micro-gas turbine plant as claimed in claim 1, wherein the walls (15) are formed of a foil.

6. The micro-gas turbine plant as claimed in claim 1, wherein the walls (15) have a curved shape.

7. The micro-gas turbine plant as claimed in claim 1, wherein the recuperator (24) has an inner tube (4) and an outer tube (3), wherein the walls (15) extend between the inner tube (4) and the outer tube (3).

8. The micro-gas turbine plant as claimed in claim 7, wherein the outer tube (3) has axial grooves (11) on an inner side thereof, the inner tube (4) has axial grooves (12) on an outer side thereof, or the axial grooves are located on both the inner side of the outer tube and the outer side of the inner tube.

9. The micro-gas turbine plant as claimed in claim 8, wherein strips (13) are arranged between at least one of the outer tube (3) and the filler (5) or the inner tube (4) and the filler (5).

10. The micro-gas turbine plant as claimed in claim 1, wherein the passages (1) for one of the fluid flows are closed off at end sides thereof by covers (6).

11. The micro-gas turbine plant as claimed in claim 10, wherein the covers (6) are welded to at least one of the walls (15).

12. The micro-gas turbine plant as claimed in claim 10, wherein adjacent ones of the covers (6) are welded to each other.

13. The micro-gas turbine plant as claimed in claim 10, wherein the walls (15) are flanged onto the covers (6).

14. The micro-gas turbine plant as claimed in claim 1, wherein the annular recuperator (24) at least partially encloses a combustion chamber (25).
